(19) United States
(12) Patent Application Publication
(10) Pub. No.: US 2012/0027510 A1
(43) Pub. Date: Feb. 2, 2012

(54) SEAT POST ASSEMBLY

(75) Inventor: Chao-Hu CHEN, Taichung Hsien (TW)

(73) Assignee: KALLOY INDUSTRIAL CO., LTD., Taichung Hsien (TW)

(21) Appl. No.: 12/848,202

(22) Filed: Aug. 1, 2010

(51) Int. Cl. B62K 19/36; B62J 1/08

(52) U.S. Cl. 403/374.2

(57) ABSTRACT

A seat post assembly includes a saddle positioning unit adapted to be mounted to a saddle. An outer tube has one end connected to the saddle positioning unit. An inner tube is received in the outer tube. An opening laterally defined in an outer periphery of the inner tube. An inner post passes through the inner tube and is received in the outer tube. The inner post has a recess laterally defined in one end thereof. An abutting member is disposed in the recess and protrudes from the opening in the inner tube for contacting with an inner peripheral wall of the outer tube. A tightening unit radially passes through the outer tube, the inner tube, and the inner post for pushing the abutting member to abut against the inner peripheral wall of the outer tube for refraining the inner tube from rotating relative to the outer tube.

### BACKGROUND OF THE INVENTION

1. Field of the Invention

The present invention relates to a seat post assembly, and more particularly to a seat post assembly for effectively refraining an inner tube from rotation relative to an outer tube.

2. Description of Related Art

Cycling has become an extremely popular recreational activity throughout the world in recent decades. As more and more people indulge themselves in cycling, a demand for innovation and improvement of bicycles and bicycle parts has arisen.

A conventional seat post assembly includes an elongated tubular housing. A sleeve is received in the tubular housing. A shock-absorbing device includes a resilient unit disposed in the tubular housing. The resilient unit includes a first coil spring and a second coil spring respectively abutting against the sleeve. Thereby, via the first coil spring and the second coil spring, a shock-absorbing effect is provided during riding.

However, despite the effects it provides, the conventional seat post assembly has the following drawbacks: for instance, the sleeve is received in the elongated tubular housing, but the sleeve is easily rotated relative to the elongated tubular housing during riding. When the sleeve is rotated relative to the elongated tubular housing, the shock-absorbing effect is reduced. To overcome this drawback, a non-rotary sleeve is provided to prevent the sleeve from rotating relative to the elongated tubular housing. However, the sleeve may gradually wear through continuous use, when the sleeve is worn, the sleeve will still rotate relative to the elongated tubular housing during operation.

The present invention has arisen to obviate/mitigate the disadvantages of the conventional seat post assembly.

### SUMMARY OF THE INVENTION

The main objective of the present invention is to provide a seat post assembly which overcomes the disadvantages of the conventional seat post assembly.

To achieve the objective, the seat post assembly in accordance with the present invention comprises a saddle positioning unit which is adapted to be mounted to a saddle. An outer tube has one end connected to the saddle positioning unit. An inner tube is received in the outer tube. The inner tube has a non-circular outer periphery. An opening is laterally defined in the outer periphery of the inner tube and communicated with an interior of the inner tube. An inner post passes through the inner tube and is received in the outer tube for engaging with the saddle positioning unit. The inner post has a recess laterally defined in one end thereof for corresponding to the opening of the inner tube. The recess has two inclined inner walls oppositely and respectively formed on two sides thereof. An abutting member is disposed in the recess. The abutting member has a surface contacting with an inner peripheral wall of the outer tube, the surface is formed with a tapered shape. An assisting member is sandwiched between the abutting member and a bottom of the recess such that the assisting member is correspondingly received in the recess. A hardness of the assisting member is greater than that of the abutting member. A tightening unit radially passes through the outer tube, the inner tube, and the inner post for abutting against the assisting member for consequently pushing the abutting member such that the abutting member tightly/loosely abuts against the inner peripheral wall of the outer tube.

The assisting member and the abutting member are substantially trapezoidal shaped for corresponding to the two inclined inner walls of the recess such that the assisting member and the abutting member are slightly movable within the recess.

By adjusting the tightening unit, the abutting member tightly/loosely abuts against the inner peripheral wall of the outer tube for refraining the inner tube from rotating relative to the outer tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an assembled perspective view of the seat post assembly in accordance with the present invention;

FIG. 2 is an exploded perspective view of the seat post assembly in accordance with the present invention;

FIG. 3 is an operational cross-sectional view of the seat post assembly in accordance with the present invention; and

FIG. 4 is another operational cross-sectional view of the seat post assembly in accordance with the present invention.

### DETAILED DESCRIPTION OF THE INVENTION

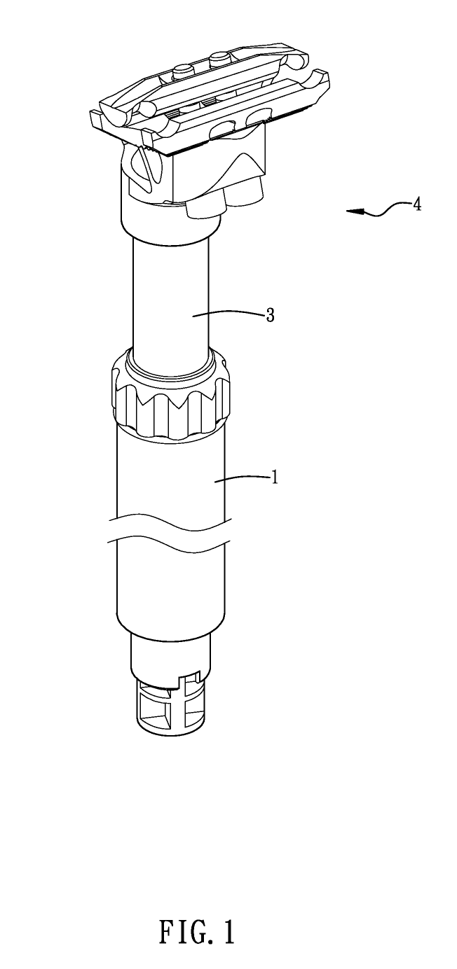

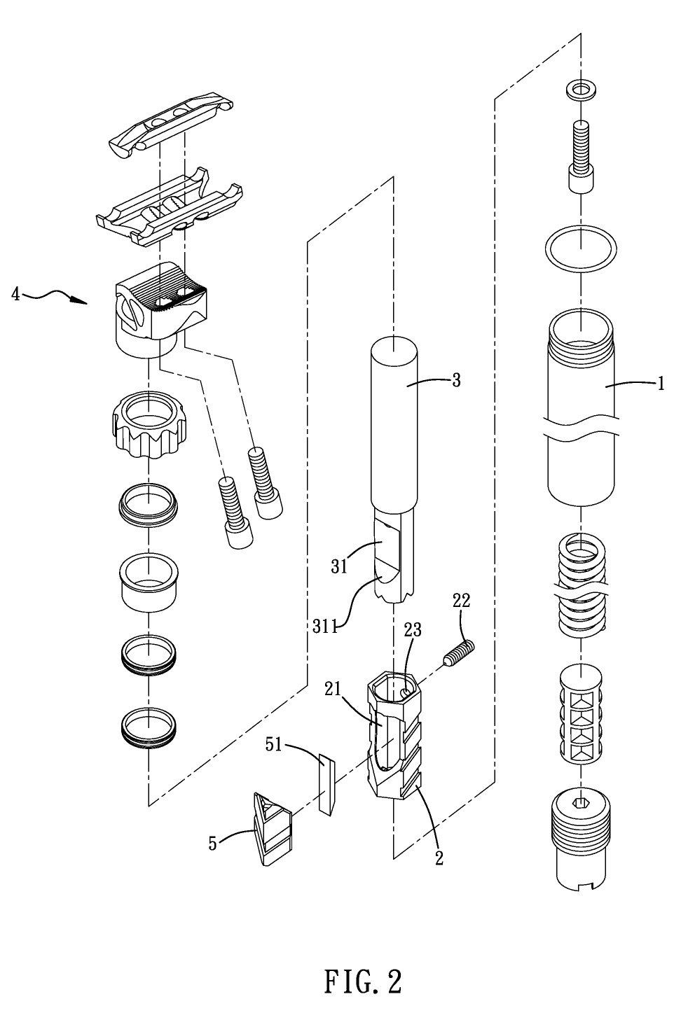

Referring to the drawings and initially to FIGS. 1-2, the seat post assembly in accordance with the present invention comprises a saddle positioning unit 4 adapted to be mounted to a saddle (not shown). An outer tube 1 has one end connected to the saddle positioning unit 4. An inner tube 2 is coaxially received in the outer tube 1. As shown in FIG. 2, the inner tube 2 has a hexagonal outer periphery. An opening 21 is laterally defined in the outer periphery of the inner tube 2 and communicated with an interior of the inner tube 2. In the present embodiment, a shock-absorbing device (not numbered) is installed in the outer tube 1 for providing a shock-absorbing effect (Structures and functions of the shock-absorbing device are well-known in the art, and are not the objectives of the present invention, therefore, only brief description is provided). An inner post 3 passes through the inner tube 2 and is coaxially received in the outer tube 1 for engaging with the saddle positioning unit 4. The inner post 3 has a recess 31 laterally defined in one end thereof for corresponding to the opening 21 of the inner tube 2. The recess 31 has two inclined inner walls 311 oppositely and respectively formed on two sides thereof. An abutting member 5 is disposed in the recess 31. An assisting member 51 is sandwiched between the abutting member 5 and a bottom of the recess 31 such that the assisting member 5 is correspondingly received in the recess 31. The assisting member 51 and the abutting member 5 are substantially trapezoidal shaped for corresponding to the two inclined inner walls 311 such that the assisting member 51 and the abutting member 5 are slightly movable within the recess 31. In the preferred embodiment, the abutting member 5 is consisted of plastic, and the assisting member 51 is consisted of metal such that a hardness of the assisting member 51 is greater than that of the abutting member 5. The abutting member 5 has a surface contacting with the inner peripheral wall of the outer tube 1, as shown in FIG. 2, the surface is formed with a tapered shape which corresponds to the hexagonal outer periphery of the inner tube 2.

Each of the outer tube 1, the inner tube 2, and the inner post 3 has a through hole 11, 23, 32 radially defined in outer periphery thereof. As shown in FIG. 2, the through hole 23 of the inner tube 2 is oppositely located relative to the opening 21. When the outer tube 1, the inner tube 2, and the inner post 3 are assembled, the through holes 11, 23, 32 are communicated with each other. A tightening unit 22 radially and sequentially passes through the through holes 11, 23, 32 of outer tube 1, the inner tube 2, and the inner post 3. In the present embodiment, the through holes 11, 23, 32 are threaded holes and the tightening unit 22 is a threaded member such that the tightening unit 22 adjustably and threadedly passes through the through holes 11, 23, 32 and abuts against the assisting member 51 for pushing the abutting member 5 to abut against the inner peripheral wall of the outer tube 1. As previously described, the assisting member 51 is consisted of metal and the abutting member 5 is consisted of plastic, such that the assisting member 51 is durable against a force exerted thereon by said tightening unit 22; whereas the plastic-made abutting member 5 elastically abuts against the inner peripheral wall of the outer tube 1 when the abutting member 5 is pushed by the assisting member 51. Therefore, when the tightening unit 22 abuts against the assisting member 51, the tightening unit 5 consequently and readily pushes the abutting member 5 to abut against the inner peripheral wall of the outer tube 1.

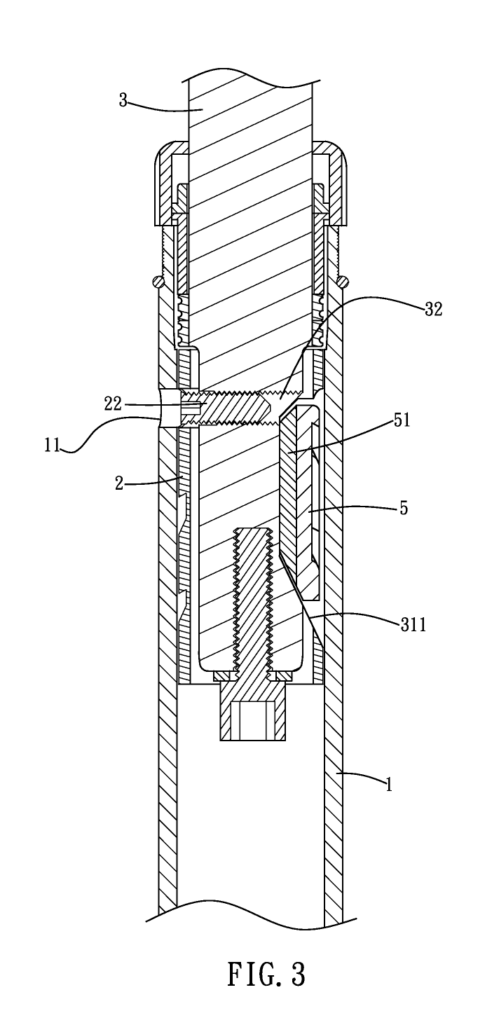

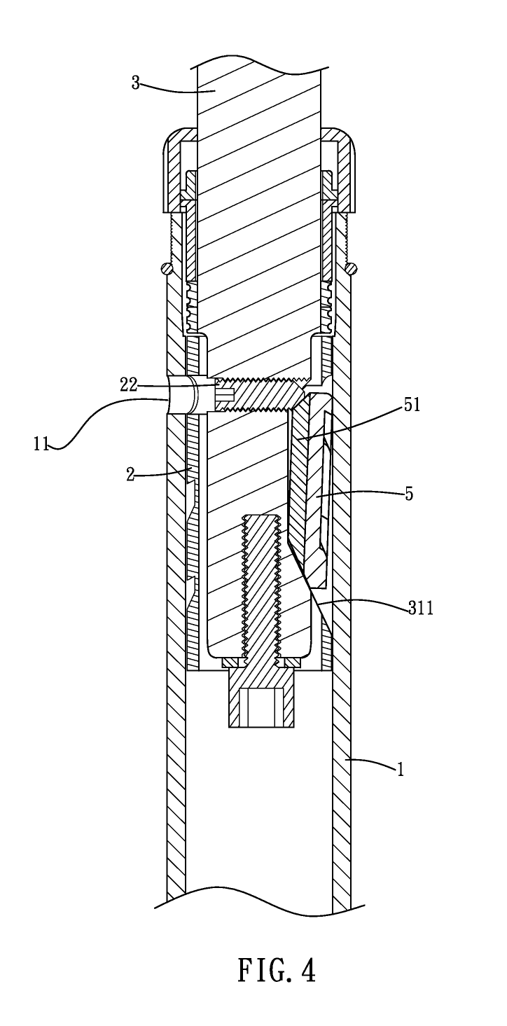

Further referring to FIGS. 3-4, operation of the seat post assembly in accordance with the present invention will be described in detailed below. By adjusting the tightening unit 22, the abutting member 5 tightly or loosely abuts against the inner peripheral wall of the outer tube 1. As shown in FIG. 4, the tightening unit 22 is threadedly adjusted and abuts against the assisting member 51, such that the abutting member 5 is pushed to tightly abut against the inner peripheral wall of the outer tube 1 for enhancedly refraining the inner tube 2 from rotation relative to the outer tube 1.

Although the invention has been explained in relations to its preferred embodiment, it is to be understood that many other possible modifications and variations can be made without departing from the spirit and scope of the invention as hereinafter claimed.

What is claimed is:

1. A seat post assembly comprising:
a saddle positioning unit adapted to be mounted to a saddle;
an outer tube having one end connected to the saddle positioning unit;
an inner tube received in the outer tube, the inner tube having a non-circular outer periphery, an opening laterally defined in the outer periphery of the inner tube and communicated with an interior of the inner tube;
an inner post passing through the inner tube and received in the outer tube for engaging with the saddle positioning unit, the inner post having a recess laterally defined in one end thereof for corresponding to the opening of the inner tube;
an abutting member disposed in the recess and partially protruding from the opening in the inner tube for contacting with an inner peripheral wall of the outer tube; and
a tightening unit radially passing through the outer tube, the inner tube, and the inner post for pushing the abutting member to abut against the inner peripheral wall of the outer tube;
wherein by adjusting the tightening unit, the abutting member tightly/loosely abuts against the inner peripheral wall of the outer tube for refraining the inner tube from rotating relative to the outer tube.

2. The seat post assembly as claimed in claim 1 further comprising an assisting member sandwiched between the abutting member and a bottom of the recess in the inner post, such that the assisting member is correspondingly received in the recess; a hardness of the assisting member being greater than that of the abutting member; the tightening unit abutting against the assisting member for consequently pushing the abutting member to abut against the inner peripheral wall of the outer tube.

3. The seat post assembly as claimed in claim 2, wherein the recess has two inclined inner walls oppositely and respectively formed on two sides thereof; the assisting member and the abutting member being substantially trapezoidal-shaped for corresponding to the two inclined inner walls such that the assisting member and the abutting member are slightly movable within the recess.

4. The seat post assembly as claimed in claim 2, wherein the abutting member has a surface contacting with the inner peripheral wall of the outer tube, the surface formed with a tapered shape.
